(19) United States
(12) Patent Application Publication
(10) Pub. No.: US 2024/0025617 A1
(43) Pub. Date: Jan. 25, 2024

(54) Paper Roll Cushion

(71) Applicant: Complete Packaging Systems Inc., Whitby (CA)

(72) Inventor: Darren Burden, Whitby (CA)

(73) Assignee: Complete Packaging Systems Inc., Whitby (CA)

(21) Appl. No.: 17/870,259

(22) Filed: Jul. 21, 2022

(51) Int. Cl. B65D 81/127; C08J 9/36; B32B 5/18; B32B 15/18; B32B 15/04; B32B 15/082; B32B 15/085; B32B 27/30; B32B 27/32; B32B 27/06; B32B 3/30

(52) U.S. Cl. CPC B65D 81/1275; C08J 9/365; B32B 5/18; B32B 15/18; B32B 15/046; B32B 15/082; B32B 15/085; B32B 27/304; B32B 27/32; B32B 27/065; B32B 3/30; C08J 2205/052; C08J 2323/06; B65D 2581/055; B32B 2266/06; B32B 2266/08; B32B 2266/025; B32B 2307/7246; B32B 2307/732; B32B 2307/306; B32B 2307/51; B32B 2553/00; B32B 7/12

(57) ABSTRACT

A deployable paper roll cushion according to the invention is provided and comprises, a top layer having an elongated raised member composed of a cushion material. Further, comprising a bottom layer having a composition composed of ferromagnetic material which is layered to a rear face of the top layer. Moreover, comprising a wrap layer in which an exposed area of the top layer and an exposed area of the bottom layer are covered, and a front face of the top layer receives a downward force from a paper roll while the paper roll is in contact with the wrap layer.

### FIELD OF THE INVENTION

The present invention relates, in general, to a paper roll cushion for protecting paper rolls from unwanted damages, and, in particular, to a paper roll cushion that is multi-layered and provides protection for transporters of industrial paper rolls.

### BACKGROUND

In the paper roll transportation industry, paper rolls are big, heavy, and expensive. Usually, paper rolls are transported in bulk carriers. For example, paper rolls can be loaded into train cars, shipping containers or vessels. One of the major problems of transporting paper rolls in bulk, would be paper rolls can be easily damaged by physical contact, exposure to moisture, dirt, contaminants, chemicals or odors.

Moreover, paper rolls are very sensitive to debris or objects inside the containers that may puncture or tear through the protective material enclosing the paper roll. When a paper roll is damaged during transport, such as gouging the side or surface of the paper roll, in some instances, the damaged side portion of the roll may need to be removed, in order to salvage the undamaged portion of the paper roll. This would then lead to an increase in waste of materials and reduction in the value of the remaining paper roll. If the owner chooses to not cut the portion of the damaged roll, but instead chooses to unroll it, it would still cost time and money to remove the damaged portion of the paper roll. In some instances, damage that has affected the roundness of the paper roll will require unrolling and re-rolling the paper roll, in order to provide a paper roll that can reliably be used in machinery, such as printing presses, or other processing equipment that must predictably feed the rolled material for processing.

Therefore, there is a need for an easily placed and repeatably adjustable cushion that can preserve the integrity of paper rolls being shipped within a transport container or vessel. Such device should be easily manufactured, low cost, reusable, and capable of being refreshed if damaged or exposed to contamination. The problem is addressed by providing easily placed cushions, that can be customized to provide additional cushioning to the product as it is being loaded into the transport container or vessel. Moreover, it should be easily adjusted to conform to the size needed and easily reusable.

### SUMMARY

Certain deficiencies of the prior art may be overcome by the provision of one or more embodiments of the paper roll cushion. These and other advantages, aspects, and novel features of the claimed invention, as well as details of illustrative aspects thereof, will be more fully understood from the following description and figures. A deployable paper roll cushion is provided and comprises, a top layer having an elongated raised member composed of a cushion material; a bottom layer having a composition composed of ferromagnetic material which is layered to a rear face of the top layer; and a wrap layer in which an exposed area of the top layer and an exposed area of the bottom layer are covered, and a front face of the top layer receives a downward force from a paper roll while the paper roll is in contact with the wrap layer.

### BRIEF DESCRIPTION OF THE DRAWINGS

A more complete understanding of the present invention may be derived by referring to the detailed description when considered in connection with the accompanying illustrative figures. In the figures, like reference numbers refer to like elements or acts through the figures.

FIG. 1 is a top, front, right view of a deployable paper roll cushion;

FIG. 2 is a top, front, right view of the invention of FIG. 1;

FIG. 3 is a right view of the invention of FIG. 2;

FIG. 4 is an enlarged right view of the invention of FIG. 3; and

FIG. 5 is a right view of the invention of FIG. 4.

### DETAILED DESCRIPTION OF THE EMBODIMENT(S)

In the exemplary embodiments of the invention, it will be described hereinafter in detail with reference to the attached drawings, wherein like reference numerals refer to like elements.

The invention may, however, be embodied in many different forms and should not be construed as being limited to the particular embodiments set forth herein; rather, these embodiments are provided so that the present disclosure will be thorough and complete, and will fully convey the concept of the disclosure to those skilled in the art.

The FIGS. 1-5 establish the components and overall structure of a deployable paper roll cushion 1, according to the exemplary embodiments of the invention.

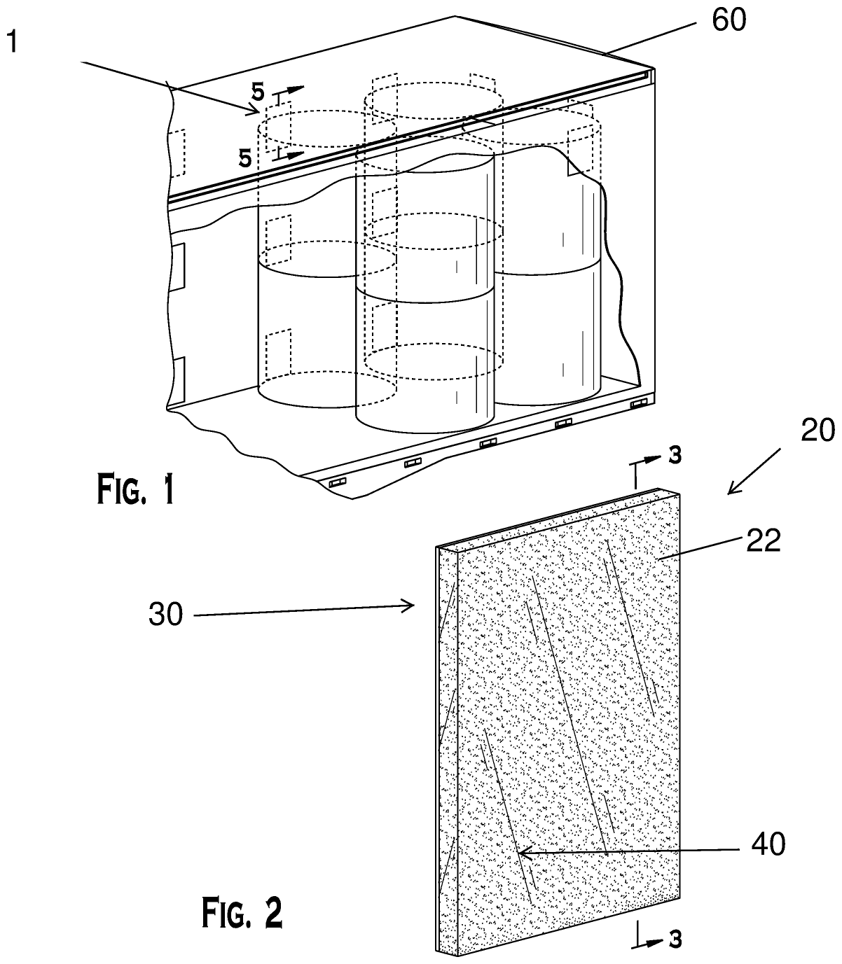

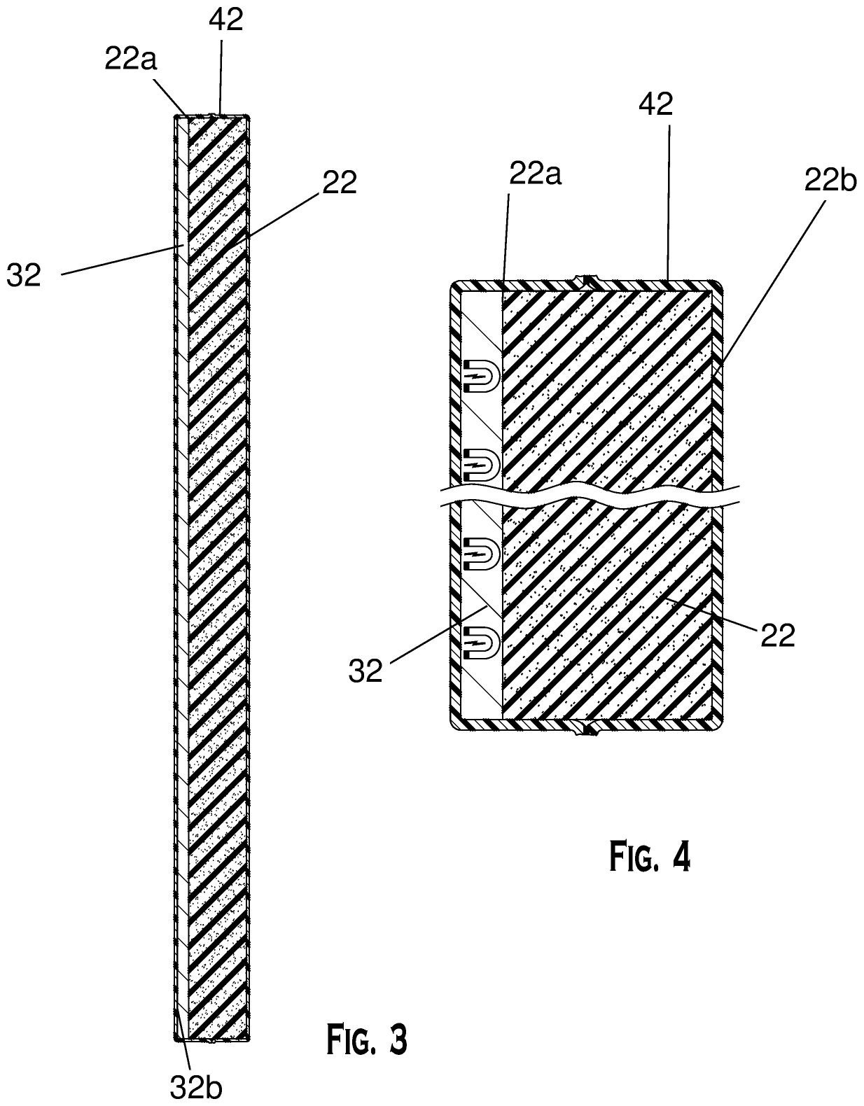

In the exemplary embodiments, the deployable paper roll cushion 1, is generally constructed in accordance with the following major components: a top layer 20, a bottom layer and a wrap layer 40 as shown in FIGS. 2-5.

In the exemplary embodiment, the top layer 20 is generally constructed with the following major component: an elongated raised member 22 as shown in FIGS. 2-5. The elongated raised member 22 is rectangular shaped. One of ordinary skill in the art would understand the applicant's design is not the exclusive embodiment. In the exemplary embodiment, the elongated raised member 22 is composed of a cushion material. One of ordinary skill in the art would understand the applicant's design is not the exclusive embodiment. In the exemplary embodiment, the cushion material may be a closed cell or open cell foam. One of ordinary skill in the art would understand the applicant's design is not the exclusive embodiment. In one embodiment, the foam of the cushion material may be polyethylene to allow for heat resistance. One of ordinary skill in the art would understand the applicant's design is not the exclusive embodiment. In another embodiment, the foam of the cushion material may be provided as a prism of foam, having a size necessary to cushion a paper roll 100. One of ordinary skill in the art would understand the applicant's design is not the exclusive embodiment. In another embodiment, the cushion material may be a sheet of foam material that is equal to, or at least 0.75″, or 1″, or 1.25″ in thickness, and equal to, or less than 2″, or 1.5″, or 1.25″ in thickness. In the exemplary embodiment, the foam is exactly 1.25″. One of ordinary skill in the art would understand the applicant's design is not the exclusive embodiment.

In the exemplary embodiment, the cushion material of the elongated raised member 22 could change due to the size of the interior of the transportation vehicle or size or density of the paper roll 100. One of ordinary skill in the art would understand the applicant's design is not the exclusive embodiment. In the exemplary embodiment, the cushion material of the elongated raised member 22 may have dimensions correlating with the bottom layer 30, however alternatively, different shapes may be provided such as triangular, circular or any other polygon or suitable shape, having the desired thickness to allow for cushioning of the paper roll 100. One of ordinary skill in the art would understand the applicant's design is not the exclusive embodiment.

In the exemplary embodiment, the bottom layer 30 is generally constructed with the following major component: an elongated plate like member 32. One of ordinary skill in the art would understand the applicant's design is not the exclusive embodiment. In the exemplary embodiment, the elongated plate like member 32 is composed of a ferromagnetic material with a high magnetism. One of ordinary skill in the art would understand the applicant's design is not the exclusive embodiment. The elongated plate like member 32 can be implemented with the use of any magnetic material with a high magnetic field, an example of one form of a suitable material for the elongated plate like member 32 is MuscleMag® Latex by Magnum Magnetics. One of ordinary skill in the art would understand the applicant's design is not the exclusive embodiment. In the exemplary embodiment, the bottom layer 30 may be provided in dimensions similar to or the same as the top layer 20. One of ordinary skill in the art would understand the applicant's design is not the exclusive embodiment.

In the exemplary embodiment, the wrap layer 40 is generally constructed with the follow major component: a protective membrane 42. One of ordinary skill in the art would understand the applicant's design is not the exclusive embodiment. In the exemplary embodiment, the protective membrane 42 is a thin layer of film material which is impervious to chemicals and moisture. One of ordinary skill in the art would understand the applicant's design is not the exclusive embodiment. In the exemplary embodiment, the protective membrane 42 can have a composition composed of saran wrap. Alternatively, the composition of the protective membrane 42 can be composed of polyvinyl chloride (PVC) or Polyethylene films. One of ordinary skill in the art would understand the applicant's design is not the exclusive embodiment.

In the exemplary embodiment, the deployable paper roll cushion 1 is generally constructed with the following major components: a top layer 20, a bottom layer 30 and a wrap layer 40.

In the exemplary embodiment, a single elongated raised member 22 of the top layer 20 is used to match a specific density or a crush strength (PSI). Alternatively, in an alternate embodiment, the top layer 20 may require multiple layers of the elongated raised member 22 in which case, a plurality of elongated members 22 are stacked in order to meet the requirements of the crush strength (PSI). One of ordinary skill in the art would understand the applicant's design is not the exclusive embodiment.

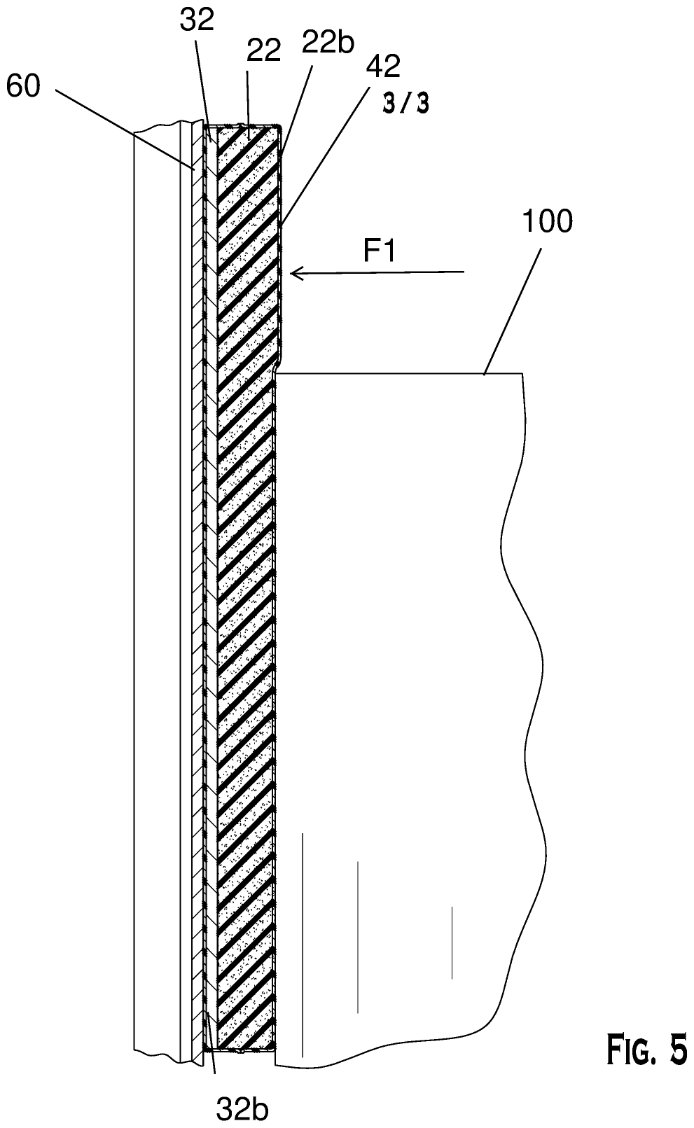

In the exemplary embodiment, the elongated raised member 22 of the top layer 20 is layered to the elongated plate like member 32 of the bottom layer 30 by making contact with a rear face 22a of the elongated raised member 22 as shown in FIG. 4. The top layer 20 and the bottom layer 30 are therefore in alignment. In an alternate embodiment, an adhesive could be applied to a rear face 22a of the elongated raised member 22 prior to attaching the elongated plate like member 32 of the bottom layer 30 to the rear face 22a. One of ordinary skill in the art would understand the applicant's design is not the exclusive embodiment.

In the exemplary embodiment, top layer 20 and the bottom layer 30 are inserted into a shrink film tunnel machinery (not shown) for efficient assembly. The wrap layer 40 fully encloses both the top layer 20 and the bottom layer 30 in which the exposed areas of both layers are completely covered. One of ordinary skill in the art would understand the applicant's design is not the exclusive embodiment. In the exemplary embodiment, the protective membrane 42 of the wrap layer 40 is a single-layered wrap using specific gauges of film. In an alternate embodiment, the protective membrane 42 is a multi-layered wrap in scenarios that require more rigorous application. One of ordinary skill in the art would understand the applicant's design is not the exclusive embodiment.

In the exemplary embodiment, the deployable paper roll cushion 1 can be utilized in both an internal transport carrier and an external open transport carrier. The deployable paper roll cushion 1 for an internal transport carrier may include dimensions of 12″×16″×1.25″. One of ordinary skill in the art would understand the applicant's design is not the exclusive embodiment. In the exemplary embodiment, the deployable paper roll cushion 1 for an external open transport carrier may include dimensions of 4″×68″×1″. One of ordinary skill in the art would understand the applicant's design is not the exclusive embodiment. Moreover, both applications have the variability to be produced in custom dimensions depending on the need and the project.

In either situation, a rear surface 32b of the elongated plate like member 32 is mounted either in a horizontal direction or a vertical direction with respect to a side of a container 60 or a vessel 60 as shown in FIG. 1. The deployable paper roll cushion 1 acts as a shield and fills the void of harmful objects that could penetrate the paper roll 100. Once the deployable paper roll cushion 1 is in place, the paper roll 100 is then placed in contact with, and flush to the protective membrane 42 of the wrap layer 40 while a front face 22b of the elongated raised member 22 receives a downward force F1 from the paper roll 100 as shown in FIG. 5. Once the paper roll 100 has arrived to the selected destination, the paper roll 100 is removed.

The deployable paper roll cushion 1 is elastically resilient and returns to its original state once the downward force F1 applied by the paper roll 100 is removed. If there is dirt or grime on the wrap layer 40, the wrap layer 40 can easily be wiped or washed to remove any debris to allow for repeated and continuous use. Moreover, if a puncture penetrates the protective membrane 42, a polyethylene tape can be applied to repair the damage and maintain the use of deployable paper roll cushion 1.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A deployable paper roll cushion comprising:
a top layer having an elongated raised member composed of a cushion material;
a bottom layer having a composition composed of ferromagnetic material which is layered to a rear face of the top layer; and
a wrap layer in which an exposed area of the top layer and an exposed area of the bottom layer are covered, and a front face of the top layer receives a downward force from a paper roll while the paper roll is in contact with the wrap layer.

2. The deployable paper roll cushion of claim 1, wherein the cushion material may be composed of a closed cell foam or an open cell foam.

3. The deployable paper roll cushion of claim 2, wherein the closed cell foam of the cushion material may be composed of a polyethylene.

4. The deployable paper roll cushion of claim 3, wherein the cushion material is a sheet of foam material that is equal to, or at least 0.75″, or 1″, or 1.25″ in thickness,

5. The deployable paper roll cushion of claim 4, wherein the cushion material is a sheet of foam material that is equal to, or less than 2″, or 1.5″, or 1.25″ in thickness.

6. The deployable paper roll cushion of claim 5, wherein the elongated raised member is a polygon.

7. The deployable paper roll cushion of claim 6, wherein the bottom layer is an elongated plate like member.

8. The deployable paper roll cushion of claim 7, wherein the wrap layer is a protective membrane.

9. The deployable paper roll cushion of claim 8, wherein the protective membrane is impervious to chemicals and moisture.

10. The deployable paper roll cushion of claim 9, wherein the top layer and the bottom layer are in an alignment.

11. The deployable paper roll cushion of claim 10, wherein the protective membrane is at least a single layer of a film.

12. The deployable paper roll cushion of claim 11, wherein the deployable paper roll cushion can be utilized in an internal transport carrier.

13. The deployable paper roll cushion of claim 12, wherein the deployable paper roll cushion can be utilized in an external open transport carrier.

14. The deployable paper roll cushion of claim 13, wherein the deployable paper roll cushion for the internal carrier can include dimensions of 12″×16″×1.25″.

15. The deployable paper roll cushion of claim 14, wherein the deployable paper roll cushion for the external carrier can include dimensions of 4″×68″×1″.

16. The deployable paper roll cushion of claim 15, wherein the deployable paper roll cushion is mounted in a horizontal position to a portion of a container.

17. The deployable paper roll cushion of claim 16, wherein the deployable paper roll cushion is mounted in a vertical position to the portion of the container.

18. The deployable paper roll cushion of claim 17, wherein the deployable paper roll cushion is elastically resilient.

19. The deployable paper roll cushion of claim 18, wherein the deployable paper roll cushion is reusable.

20. The deployable paper roll cushion of claim 19, wherein the deployable paper roll cushion is heat resistant.
